(19) United States
(12) Patent Application Publication
(10) Pub. No.: US 2004/0193878 A1
(43) Pub. Date: Sep. 30, 2004

(54) Method and data processing device for transferring data via various interfaces

(76) Inventors: Markus Dillinger, Munchen (DE); Josef Eichinger, Neufinsing (DE); Rudiger Halfmann, Otterberg (DE); Wolfgang Zirwas, Grobenzell (DE)

Correspondence Address: MORRISON & FOERSTER LLP, 1650 TYSONS BOULEVARD, SUITE 300, MCLEAN, VA, 22102, US

(21) Appl. No.: 10/486,717

(22) PCT Filed: Aug. 1, 2002
(86) PCT No.: PCT/EP02/08600

(30) Foreign Application Priority Data
Aug. 17, 2001 (EP) 01119921.3

(51) Int. Cl. H04L 9/00

(52) U.S. Cl. 713/165

(57) ABSTRACT

The invention relates to a method for transferring data (D) via an interface (VA, BS, A) of a communication system (GSM/A) between at least one emitter (MS1) and at least one receiver (MS2), at least part of the data (CD) being transferred in a secure manner. The aim of the invention is to transfer the data in an efficient, but nevertheless secure, manner. To this end, the part of the data (CD) to be transferred in a secure manner is transferred via a secure interface (VA, GSM, A) and the remaining part of the data (ND) is transferred via an interface (VB, WLAN, B) which is not especially secure, especially another communication system. Basic data for the reproduction of a basic information message can be selected and/or transferred as the data (CD) to be transferred in a secure manner. A code for decoding coded data (ND) can also be transferred as the data (CD) to be transferred in a secure manner. The rest of the data (ND) is then transferred as data (ND) which is encoded by said code (CD). The secure interface (VA, GSM, A) is embodied in a secure manner in terms of availability and/or in terms of data security.

The invention relates to a method for transmission of data via an interface of a communications system with “the generic features of patent claim 1 or data processing devices to execute such a method.

Currently there are various types of communications systems, especially radio communications systems, which are distinguished from each other by a wide variety of criteria. In particular cellular mobile phone systems in accordance with the GSM (Global System for Mobile Communication) or the UMTS (Universal Mobile Telecommunication System) standard make it possible to transfer data securely, whereby security is taken to mean security both of the actual encoding of the data or data encryption as well as that relating to the guaranteed provision of connections.

Authentication and authorization to identify and authorize a subscriber who is using his mobile phone to establish a connection to a network-side station takes place within the framework of such communications systems. The corresponding methods thus provide a high level of security since only direct subscribers of a single connection between a subscriber-side station and the corresponding send-side stations can send or receive data legally via a corresponding radio interface. Through the direct assignment of the connection to a quite specific, subscriber registered on the network side, charging (accounting, billing) for services requested or utilized is also possible.

A further benefit of these systems lies in the high mobility of the subscribers provided by an appropriate mobility management. This makes it possible to handover a send/receive station from one radio cell to an overlapping adjacent radio cell without having to interrupt the connection. Network-side procedural sequences coordinate the handover of the send/receive station in such a way that a complete transmission of data via the handover radio interfaces is possible without data loss or critical data delays.

Disadvantageously the administrative overhead with such systems is very high, which leads to high connection costs per volume of data transmitted.

By contrast there are radio or cable-based data networks, especially local area networks in accordance with simple transmission standards, for example the WLAN (Wireless Local Area Network) or the H2 (HiperLAN Type 2) standard for which use is mostly restricted to individual buildings or building complexes. With these types of communication systems there is access to a shared transmission medium by a plurality of stations which are mostly set up as computers. On one hand this allows large volumes of data to be transmitted in a short time while simultaneously keeping costs low, but has the disadvantage of not allowing any data security since all stations can access all data. Although access restrictions to data stored in one station can in principle be set up this is generally only able to be provided low levels of security against unauthorized access and involves significant programming overhead.

With such systems billing of services or service features of which use is made is especially not possible since an authentication and authorization of a specific subscriber is only possible under some conditions or is not possible at all.

As regards mobility there are two basic situations, one is for networks that are freely accessible for access by third-party stations which offer the correspondingly low level of security and the other is networks which only allow access to already registered third-party stations equipped with the corresponding passwords, which very much restricts mobility

Currently further communications systems are being developed which are designated as ad-hoc networks. These communications systems comprise a plurality of mostly mobile stations which can establish radio connections with any stations. The stations have a dual function in such cases, on the one hand as a self-contained send/receive device for a subscriber and on the other hand as a relay station for data which is to be received from remote stations and forwarded to other remote stations.. For these types of communications systems the appropriate routing algorithms and a corresponding subscriber management is created.

In summary the communications systems are thus broadly divided into two classes. The transmission systems of the one class (class A) in such cases have available all the characteristics listed above which are typical of cellular radio systems. The transmission systems of the other class (class B) only have some of these characteristics and corresponding methods or do not have them at all. Transmission systems of this second class B are the local data networks given above as examples. These can also exist either to provide full coverage or only exist in locally restricted islands, in which case, with the last example mentioned, central management of the various islands, if it is possible at all, is a very expensive option.

To make adequate data security possible authorization, if provided in the corresponding system, takes place. In such cases encryption codes are normally sent by letter, telephone etc. to a subscriber, which, especially in the case of written correspondence, involves relatively great expense and significant delays before the first data can be transmitted. Because of the technology used the corresponding codes can only be issued once, meaning that a scarce resource is involved. The scope of the key information to be transferred is small. Expensive encryption techniques, typically using dynamic assignment of codes, employing continuous encryption methods, only partly encrypting transferred information, guaranteeing a staged decryption of transferred information, such as with a dynamic assignment of a QoS (Quality of Service) or allowing dynamic booking into a data stream currently being transferred cannot be realized for systems of the second class B.

The object of the invention is to propose a method for transmission of data via an interface of a communications system which uses the advantages of the different types of communications system in combination. Further the corresponding data processing devices to execute such a method are to be provided.

This object is achieved by the method with the features of patent claim 1 or data processing devices with the features of patent claims 10 or 11.

A method for transmission of data via an interface of a communications system is especially effective which the data to be transmitted is divided up into subdata volumes, in which case a part of the data to be transferred securely is transmitted via a secure interface, for example an interface in a cellular radio communications system in accordance with GSM, and the remaining part of the data is transferred via an interface which is not specifically secured, for example an interface in a conventional data network. In this way small volumes of data to be transferred securely can be transmitted via a secure data connection, whereas the remaining generally larger volumes of data can be transmitted via an interface of a communications system which, although only providing a low level of data security or none at all, allows a high data throughput. Data in such cases is taken to mean all forms and kinds of data, information and signals which can be exchanged via an interface of this type, especially authentication data, authorization data, security information, billing data, localization information and mobility data.

Advantageous embodiments are the subject of dependent claims.

In an advantageous way, when a volume of data to be transferred is divided up, the part of the data to be transferred securely is selected or transmitted from basic data for restoration of important basic information. For the transmission of an image for example this can be data which allows a rough scan of the image on the receiver side in the case of a loss of the remainder of the data. The remaining parts of the data consisting of this data supplementing the basic information, can then be transferred for example via an interface that is not specifically secured, of a local data network for example, in order in the final analysis to make possible the complete reconstruction of the image. This type of procedure ensures that significant underlying data components are securely transmitted while supplementary data components are transmitted via a non-secure interface or only a conditionally secure interface. In the worst case a loss of this data, although a disadvantage, is still able to be coped with on the receiver side for the desired purposes.

The parts of the data to be securely transmitted can however also alternately or additionally consist of a code for decrypting coded data, in which a code required for decryption is then transmitted via the secure interface while the correspondingly coded data is transmitted via the not specifically secured interface. On the receiver side this means that a large volume of data which was transmitted via a local data network can be easily decrypted with the assigned code received via the secure interface. This procure offers the particular advantage of enabling the majority of the data or all the data to be transmitted to be sent after a corresponding encryption code via a data network with a high data throughput, in which case a certain level of security is guaranteed by the preceding encryption. Access by third parties to this encrypted data is not critical without the code transmitted via the secure interface, to which the third party does not have access.

Encryption of data is usefully undertaken in a specific division device which can be set up in a subscriber's mobile send/receive station. The corresponding send/receive station then features two external interfaces, for example one interface to local data networks and another interface to a cellular radio communications network. The separation device separates and/or encrypts incoming data and then distributes this accordingly to the two interfaces. On the receiver side the data transmitted and received via the two interfaces is then recombined accordingly into a single reconstructed data stream and where necessary decrypted. This means that, if required, the division device can divide the data up into encrypted data and key data, but can also divide it up into important and unimportant data components.

In a particular such as method allows transmission of charging-relevant data after the corresponding authorization and authentication. Since the secure interface as a rule allows two-sided transmission in both directions, this type of charging-relevant data can be exchanged and transmitted without any problems.

Advantageously this type of procedure also allows optional use of only one of the two interfaces. This makes possible, especially in the case of a continuous secure connection, interim transmission of the data that does not have to be transmitted specifically secured via interfaces of local data networks, provided the corresponding send/receive station is currently in the area of such a local data network. If access to such a not specifically secured network, such as the local data network, is temporarily not possible, the data which is not be transmitted specifically secured can also be transmitted for such periods via the secure interface. Although for such periods this leads to a high load on the secure interface, it at least allows the splitting up of the data to be transmitted in periods when it is possible to access a network of the other system. The same applies correspondingly to the case of an overloading of the not specifically secured data network.

To rapidly prepare to access to another communications system it is especially advantageous if the corresponding information about access rates and such like can be transferred to the appropriate send area before a send/receive station arrives in it.

The appropriately equipped data processing devices are useful for implementing these types of procedures. The splitting up of data into data to be transmitted securely and data not specifically to be transmitted securely can be undertaken here in a send/receive station which features such a data processing device and is operated as a subscriber's mobile station. These types of data processing devices for splitting up or correspondingly combining data streams can however also be provided on the network side, e.g. at service computers which allow access to general data. In this case the data can already have been split up at an earlier stage by the data processing device for accesses, so that an accessing subscriber on one side accesses a data storage area with data to be transferred securely via a secure interface and on the other side accesses a data storage area with data which is not to be transferred securely with an access via a local data network or similar.

This means that a secure interface can be especially secure as regards availability and the lowest possible data loss during transmissions, but can however be alternatively or additionally secure as regards data security with a view to unauthorized access to data by third parties.

A exemplary embodiment is explained below in more detail on the basis of the drawing. The drawing shows:

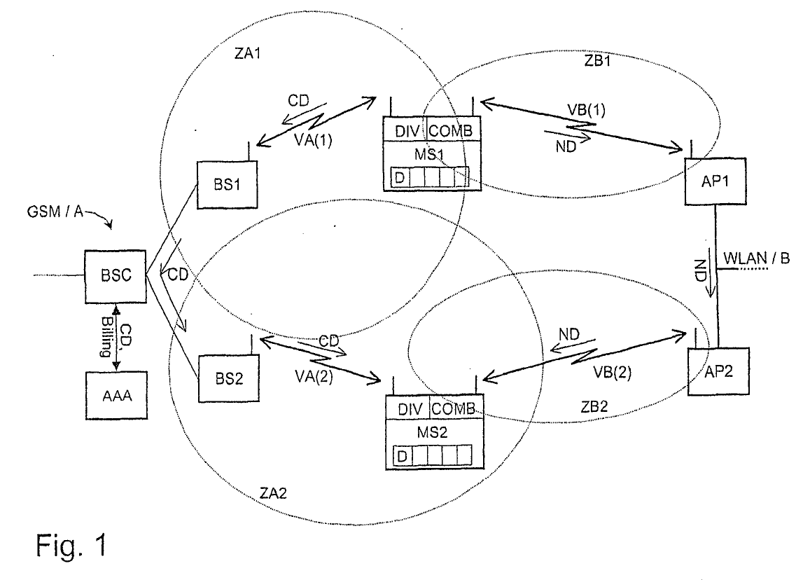

FIG. 1 a schematic diagram of different devices of different types of communications systems, which allow a combined transmission of data and

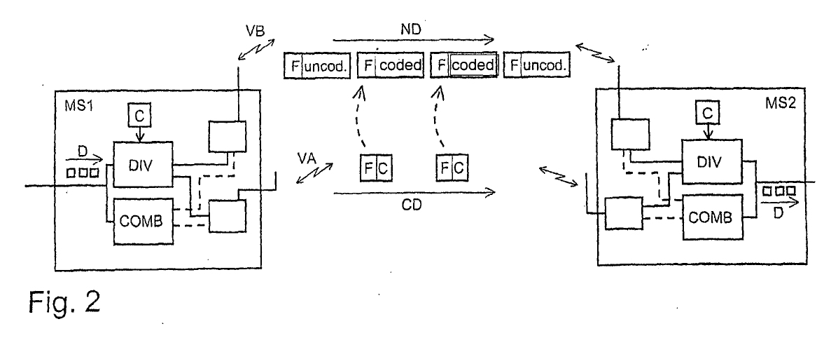

FIG. 2 a schematic diagram of the splitting up of a stream of data into a securely transmitted and non-securely transmitted part data stream.

As can be seen from FIG. 1, a typical arrangement of different communications systems with the corresponding interfaces consists of a plurality of individual devices of which the schematic diagram only shows a small part. For a communications system with a high level of secure transmission both as regards preventing unauthorized accesses to the data and also as regards the availability of the interface, the diagrams show a first communications system A with devices of a GSM radio communications system. This system typically has two base stations BS1, BS2 controlled by a base station control center BSC. The base station control center BSC is also connected to other network-side communications system devices. In the exemplary embodiment shown each of the base stations BS1, BS2 serves at least one radio cell ZA1 or ZA2, in which case the two radio cells ZA1, ZA2 in the present exemplary embodiment partly overlap each other, so that a subscriber station MS1, MS2 can move from the first radio cell into the second radio cell ZA1 or ZA2 without an existing data or information transmission having to be interrupted.

As an example of a second communication system B with a not specifically secure data transmission option a local data network, especially a local radio data network WLAN, is shown here. The diagram shows two access points AP1, AP2 with radio interfaces for access by subscriber stations. Further the access points feature an interface between themselves and other access points or other network devices which is shown in the present example as a cabled interface. Each of these access points AP1, AP2 forms at least one radio cell, in which case the two radio cells shown, ZB1 or ZB2, do not overlap in the present exemplary embodiment. A subscriber station MS1 communicating via the first data network radio interface AP1 must thus, when changing to data network radio cell AP2, interrupt the connection or transmission and re-establish it. Even with overlapping data network radio cells ZP1, ZP2 interruption or a new set-up of a radio connection would normally be required since for a radio data network devices for coordinated handover of a Subscriber station from a first to a second data network radio cell ZB1 or ZB2 are missing.

A first station MS1 and a second station MS2 are shown in the present exemplary embodiment as subscriber-side stations. To make matters simpler the first station MS1 should be seen below as a sending station MS1 featuring data D which is to be transferred to the second station MS2, in which case to simplify matters this second station should subsequently be regarded as the receiving station MS2.

However other situations are also possible, for example sending or receiving stations which are assigned to other communications systems and which communicate via the two communications system shown here A, B with one of the two stations MS1, MS2. It is also possible to merely use a memory device as a further station which centrally provides data for retrieval by one of the two stations MS1, MS2 or receives it from them. In particular communication with data exchange in both directions between two stations MS1, MS2 is also possible.

An especially preferred method for transmission of data between two stations MS1, MS2 will be described below with reference to FIGS. 1 and 2. In this case it is assumed for the example that data D is to be transmitted from the first, sending station MS1 to the second receiving station MS2. In the present exemplary embodiment a data connection can be established between the two stations MS1 and MS2 both via the first communications system GSM/A and also via the second communications system WLAN/B, since both stations MS1, MS2 have send/receive devices which enable the two stations MS1, MS2 to establish a communications connection VA or VB both with base stations BS1, BS2 of the first communications network GSM/A and also with access points AP1, AP2 of the second data network.

A first communications connection can therefore be established for transmission of data from the first sending station MS1 via a first secure radio interface VA (1) to the first base station BS1, from the latter via the first communications system GSM/A to its second base station BS2 and from there via a further secure radio interface VA (2) to the second receiving station MS2. A further communications connection can be established from the first, sending station MS1 via a first data network radio interface VB(1) to the first access point AP1 of the second communications system WLAN/B, and from there via the data network to its second access point AP2 and from their via a second data network radio interface VB(2) to the second, receiving station MS2. This second data transmission path is however to be viewed as not specifically secure or as insecure in comparison to the first path mentioned.

For transmission of the data D to be transmitted this data is routed in a first, sending station MS1 to a data processing device DIV. The data processing device DIV divides the incoming data D into two data streams ND, CD, in which case one data stream features data to be transmitted securely CD and the other data stream features data not specifically to be transmitted securely ND.

From the data processing device DIV, which is thus to be seen as a separation device or a division device DIV, the data to be transmitted securely of the send device is routed for a transmission via the secure radio interface VA and the secure first communications system GSM/A and is finally transmitted via this secure communications system GSM/A to the second, receiving station MS2. The normal data ND which is to be transmitted not specifically securely is routed from the data processing device DIV of the send device for a communication via the data network radio interface VB and the non-secure or at least not specifically secure communications network WLAN/B to the second receiving station MS2.

The second, receiving station MS2 accordingly features a data processing device COMB which can also be referred to as a reconstruction or combination device COMB. This data processing device COMB obtains from the corresponding receiver devices of the second receiving station MS2, the secure data CD received via the secure radio interface VA(2) and via the not specifically secure data network radio interface VB(2) obtains the normal, not specifically secured data ND. The data processing device COMB combines the correspondingly received data streams or data ND, CD and reconstructs as far as possible the original data to be sent D, in order to edit this data accordingly for final processing, for example output through a loudspeaker or to a computer chip.

In a useful way the individual data packets to be transmitted in the dividing data processing device DIV are to be provided with a marker or flag F which then allows a unique assignment in the combining data processing device COMB to the individually received data packets or data CD, ND.

Various criteria can be applied for the division of the data to be transmitted into two separate data streams ND, DC. In accordance with a first exemplary embodiment security against unauthorized access to a large volume of data to be transmitted can be used as a criterion. In this case the data to be transmitted D can be encoded with a code C, which can be provided by a code generation device. In this case the code or key C is transferred as data to be transmitted securely CD via the first secure communications network GSM/A, whereas the encrypted or coded data will be transmitted as normal data ND not to be specifically secured via the second not specifically secured communications network WLAN/B.

A further typical criterion for the division of a data stream can comprise the fact that specific components of the data D are to be securely transmitted to the receiver in any event for reconstruction of at least the required information whereas the remaining data elements of the data to be transmitted are merely viewed as additional information to increase the quality of the reconstructed data. Typically in such a case roughly scanned data of an image can be transmitted via the secure interface and the secure communications network GSM/A from the dividing or splitting data-processing device DIV while a large volume of remaining data is transmitted as normal data DN that is not specifically to be secured DN via the not specifically secured communications network WLAN/B. On the receiver side it can thus be assumed that there is a very high degree of probability that at least the data CD transmitted via the secure communications Network GSM/A can be reconstructed so that for example a roughly scanned black and white image can be reconstructed whereas the data ND transferred via the not specifically secure communications network WLAN/2 serves to increase the resolution of the reconstructed image and to incorporate color elements. Other criteria can for example be significant data of a database which is to be transferred securely whereas additional information data can be transferred via a not specifically secured path.

As can be seen from a FIG. 1 a connection to a network-side accounting device AAA can also be established if the secure communications network GSM/A features a device for authorization, authentication and accounting (AAA: Authorization Authentication Accounting). This allows access by the first station MS1 to a specific service or data memory, in which case this specific service or the data to be retrieved can only be accessed in return for the corresponding billing. After the connection is established the corresponding billing information is forwarded to an appropriate billing center which then makes sure that the subscriber is sent a bill which is to be assigned to the first station MS1.

The exemplary embodiment described here is preferably based on the concept, in addition to the actual desired connection to a high-bit-rate radio system, for example WLAN or HiperLAN/2 (H2), of establishing an additional connection to a known mobile radio system such as GSM-GPRS (GPRS:General Packet Radio Service) or in future UMTS with a very low data rate. Via this additional connection functions of this system which is well designed for this purpose are made available to the less qualified transmission system.

Basically any information to be exchanged between the two communication partners or stations can be represented by a data sequence, which in its turn can be split into two or more subdata sequences. In the exemplary embodiment described here this is the data D which is divided up into data streams CD, ND.

In an advantageous way class A systems, such as for example GSM provide hallmarked security mechanisms, whereas by contrast the class B systems, for example the WLAN described previously, have no security mechanisms or only “weak” security mechanisms but have a high data rate.

The individual data sequences can now be transmitted depending on the application via the two different communications systems, especially radio communications system A, B, in which case the receiver or the receiving station MS2 combines the data or data sequences CD, ND of the two receive paths VA(1)-A-VA(2) or VB(1)-B-VB(2) are combined into a resulting data stream or data D to be reconstructed.

The individual data or data sequences can however be secured in different ways. The security information would be transmitted in this case via the class A secure communications system while the remaining data will be transmitted via the other communications system B. The receiving station MS2 uses this information which it has received via the secure communications system A to decode the data sequences or data which it has received or is receiving via the class B communications system. In addition to an encryption code for coding or decoding data it is also naturally possible to select a division in which the data is mutually complementary.

Usually, in addition to the user data stream, a wide variety of signaling information is transmitted in the most diverse types of communications system. Depending on need, this information can be transmitted in the arrangement described here via the class A communications system and/or the class B communications system. The receiving station or the receiving service accordingly receive signaling information via one or both communication paths.

Especially with GPRS or UMTS a continuously active connection or at least a ready connection (always-on connection) is possible for which the corresponding radio cells ZA1, ZA2 are only occupied by the actual small volumes of data transmitted, so that in this way very many different users or stations can be supplied. Methods such as so-called “soft handover” or so-called “fall back solution” are also possible.

With the principle of the exemplary embodiment described here a large number of embodiment variants can be implemented.

In accordance with a first embodiment variant data D is requested via a secure communications system A by the subscriber from their station MS1 at a further station, in which case this data D of the requesting station MS1 is transmitted via the same communications system A. Class A communications systems in this case preferably have all the necessary security methods such as authentication, authorization and coding options, so that this can be designated as a “secure system”. This means that in particular support for charging and billing for the services or data used is also possible. From the ground up this embodiment variant involves known standard methods from mobile radio which are thus only mentioned to provide a complete picture.

In accordance with a second embodiment variant the data D is transmitted via a Class B communications network which has no security or at least not all of the security methods mentioned here as possible. With these communications networks B the subscriber of a service cannot be uniquely identified. The lack of security methods means that neither authentication nor authorization nor encryption (security) is supported so that the data cannot be protected against manipulation and misuse.

Unique billing is also impossible (accounting, billing). This embodiment corresponds for example to a radio system which would be realized on a basis of small radio islands.

With a third embodiment variant a release of various qualities of service, e.g.. for low or high resolution with video data streams, during the run time or during the connection is realized. The data needed to use a service can be encoded completely or in sections. This allows different qualities of the same data content to be provided to different groups of users, e.g. free of charge or chargeable. The billing information for this would be communicated on a central basis to a central billing service using a full-coverage Class A communications system.

With a fourth embodiment variant encryption mechanisms will be used for the authentication/encryption at higher layers of the ISO OSI Layer Model. The method described here makes it possible to take account of or to use the corresponding protection mechanisms in lower layers in an embodiment, which significantly improves security. The Class A secure communication system in this case not only transmits the security-relevant information, e.g. the authentication code (higher-layer code), but preferably also the codes of lower layers (lower-layer code), especially scrambling codes and puncturing regulations, in which case this transmission can take place either only at the start of a connection/session or also blockwise or continuously during the connection. In the Class B communications system without specific security the scrambling code or the puncturing regulation are loaded into the processing process of the physical layers for example in order to process the received data stream accordingly.

The fifth embodiment variant comprises a plurality of individual subvariants for the third and the fourth embodiment variant. This includes in particular the one-off or repeated transmission of codes or keys via the secure communications network GSM/A, which for example in accordance with UMTS or GSM authenticates its users or subscribers and permits or authorizes them to access the transmission system, in which case the last-mentioned transmission system does not feature a comparable method. Such a method can especially also be referred to as a symmetrical method in which data is transmitted split up via two different secure paths, by contrast with asymmetrical methods in which for example a code is first exchanged before being followed by data encrypted with the key.

These subvariants include features such as ongoing authorization of a service, a blockwise release of a service for a prespecified data volume or period of use, the setting up of key depots especially in mobile stations for online or offline use of a service or data record, in particular for audio or video data, the transmission of codes for encryption in uplink connections for the not specifically secure communications system WLAN/B, in which case this can also be undertaken once, in blocks or continuously, and the separate transmission of codes to access point AP1, AP2 of a local, isolated radio system via radio or line-based systems.

In accordance with a sixth embodiment variant the data, which is transmitted for use of a service is divided up and transmitted via different systems This corresponds for example to the illustration already shown of on one side data of lower-quality transmitted with the transmission of the corresponding data elements via the secure communications system A and on the other side data to create a higher quality, in which case its corresponding large-volume data component will be transmitted via the not specifically secure class B communications system e.g. H/2.

In a seventh embodiment cellular, heterogeneous networks, e.g. local radio data networks with very many different operators are considered, in which case with such heterogeneous networks the multiplicity of registration procedures when changing an operator can be dispensed with which would otherwise have to be undertaken again and in a time-consuming way for each subnetwork or each operator. This simplifies the realization of a seamless vertical handover for mobile subscribers. In this case two connections exist, with one connection always remaining in existence for control functions, especially via a secure communications network in accordance with GSM or UMTS. However there are handovers between the individual local radio networks.

In accordance with an eighth embodiment variant information which is a transferred to the terminals via the available full-coverage radio system is used to simplify the handover between the various cells of the not specifically secure radio system B. Via a secure communications system, in which a station is logged in or registered from end to end, preliminary announcements are transferred as information which include data about local radio networks WLAN to be reached later so that a connection set-up in such a local data network can be simplified. Whereas in the normal manner there must be a continuous search by a station for radio cells VB(1), VB(2) to enable a connection with an access point AP1, AP2 of a local radio data network WLAN to be established, and also measurements have to be performed after such a radio cell has been identified, to set ideal access times and access parameters, this data is already transmitted in advance via the other communications system. To provide such data memories with the appropriate databases can be provided in the other communications system.

In accordance with a ninth embodiment variant it is possible to introduce an optimized coding method which is based in particular on incremental redundancy, i.e. redundant data is sent on request. To this end the additionally needed redundancy is sent for example via an error-free GSM or UMTS channel. This reduces the danger of a multiple transmission of the redundancy information. In the final analysis this reduces the delay and lost capacity.

A tenth embodiment variant relates to the automatically set up networks, known as ad-hoc networks in which information must be transmitted via mobile routers for connections from one end point another end point. In practice this should take place in as loss-free or low-energy a way as possible, which however requires a knowledge of at least the direct neighbors or the directly adjacent station to enable the minimum possible send power to used. Since especially for this localization systems will play an ever greater role in the future the position data of a subscriber or a station can be used for such an alternate routing algorithm.

In accordance with an eleventh embodiment variant a communications network in accordance with the 2G/3G standard is considered which is able to manage ad-hoc terminals or stations. As well as the routine algorithm other subscriber management relating to connection initiation, connection release, authentication, authorization can be undertaken by this 2G/3G communications network. A further example of this is the air interface to be used between the individual routers, in which case between for example the first two routers the secure communications network in accordance with GSM can be used, whereas in continuing further connections only UMTS can be used. Here too in an advantageous way the control or control level with GSM is again full-coverage in the connection state.

In accordance with a twelfth embodiment variant, data, as already described in the introduction, can be split up and transmitted via two different communications networks. For the case of a moving station which leaves one of the communications networks in the interim and does not re-enter such a communications network until later there can also be provision that for such interim periods all data is transmitted via the remaining communications network. This applies especially to situations in which the secure communications network GSM/A makes a connection possible on an ongoing basis and the not specifically secured communications system only provides it in the form of local, non-overlapping data networks.

This thus gives significant advantages in that expensive mechanisms for authentication, security or encryption, billing and accounting can be managed using one system, whereas in the overall network system types used in other ways will be accordingly downgraded to “load islands”, which significantly reduces the installation expense and the operating costs of these systems.

Advantageously this adds value to systems without specific security mechanisms, such as HiperLAN/2. This is of major advantage since H2 systems, especially in an introductory phase, are operated at many widely-dispersed locations, called hot spots, airports, . . . independently of each other, so that an end-to-end uniform security concept could otherwise only be implemented with difficulty.

Especially advantageous too is the procedure for continuous encryption and decryption of data, in which case the codes can be transmitted once, in blocks or continuously. Codes can especially be regenerated for each connection, but can also be extracted from an existing pool and used. The transmission can also be used for the transmission of information in uplink connections. A server sends keys or codes with which the data must be encrypted in an uplink connection.

Another advantage is that supplementary information such as image content for higher image quality can be saved online and in sections. Whereas basic indispensable data is transmitted during a continuous connection which secures basic information, The transmission of further data can be undertaken in the interim via other networks, in particular local data networks.

Advantageously a dynamic release of the duration of use without a reconfiguration or a reassignment of evidence of authorization is possible. For example the duration can be set to any length in which a new film will with high quality can also be viewed by non-paying subscribers. Thereafter the film can only be viewed with the low quality so as not to exclude the subscribers from watching and the rest of the film but to give an incentive for also using the corresponding chargeable service with higher transmission quality.

It is also advantageous that no specific knowledge of the codes is required on the terminal or receiving station side. There are also keys which do not have to be stored since keys C are generated in the station which divides or encodes the data and can then be transmitted via a separate, secure data transmission path.

When changing between cells of the home communication system support for mobility functions by overlaid network functionalities is especially advantageous. It is useful to use procedures which are also valid across the boundaries of the local, isolated radio communications system.

Especially advantageous is also the option of supporting a vertical handover by homogeneous security systems. This can be organized by a central security entity in a communications network, especially mobile radio network GSM/A, in which case the security entity is independent of the technology of the data transmissions or the specifically selected service. This means that vertical handovers can be performed between the widest variety of operators and technologies very quickly without time-consuming authentication and billing. This makes it possible for example for a subscriber with their station MS1 to go through various department stores in a town and always have immediate access to the local servers in them.

In an advantageous way an optimized coding method is also possible, based in particular on incremental redundancy. With this method more or less redundancy is requested and sent depending on the error rate of the received data. This method is intrinsically very effective. Critical are situations in which the redundancy can again no longer be received, for example because of a radio channel which is once again very heavily disturbed. If only the requested redundancy is transmitted via the secure further radio channel a further optimization of the principle of incremental redundancy is to be expected.

Also advantageous is the option of higher-ranking security systems in the sense defined here being able to use cabled systems, such as conventional data networks for example.

Although with the method of operation proposed the disadvantage of an additional load on the secure communications network GSM/A is to be expected, the advantages of such a system outweigh this. Another conditional disadvantage is that a connection is to be established to two different radio systems at the same time, i.e. both technologies must be available. However it is possible in an advantageous way here to refer back to more complicated security methods as a fall-back level if no access to secure communications networks in accordance with GMS, GPRS or UMTS is possible.

In a useful way an agreement of the operators of different communications systems on a common method should also be made.

The point to be stressed in particular here is the proposed set-up of two connections to different radio systems, of which one connection should be a secure connection of higher standard in accordance for example with 2G or 3G, which should usefully be retained throughout the entire transmission. Only the minimum volumes of data are sent via this 2G or 3G connection which should allow already fully developed AAA methods from 2/3G to be transferred to new broadband systems, e.g. H2.

As regards the introduction of such a method, a distinction can be made between different basic situations. Before a service begins to be used a subscriber identifies himself via his station to the provider of the service when booking this service and before making use of the service via the secure communications network GSM/A and then obtains the access authorization to this service, e.g. an identification, a password etc. This access authorization remains active during the entire duration of use and must only be entered or regenerated during renewed use or a renewed booking in. To increase security in this case a password or code will be regularly changed.

If a station is already using the service, the release of the service is generally a continuous process and will be realized, as for example with pay TV, by the encryption of the data stream.

A further situation arises from the point at which use is concluded. If use is made in such cases of chargeable services, the start of use can be identified and billing can be undertaken. If the distribution system, such as an isolated Hiper LAN radio cell, has no end-to-end uplink to the billing server, the duration of use cannot be determined. The method described here enables the duration of use to be included for billing since the booking-in time is known in the secure communications network. This means that charging and settlement are possible.

A further case arises from the non-existent connection or offline situation, where a subscriber or his station copies an encrypted data record onto his personal data medium with or without prior release or approval by the provider and only then will it be decrypted by a corresponding method using decryption codes or evidence of authorization.

1. Method for transmission of data (D) between at least one sender (MS1) and at least one receiver (MS2), in which at least a part of the data (CD) is to be transmitted securely,
characterized in that
the part of the data to be transmitted securely (CD) will be transmitted via a secure interface (VA, GSM, A) at a low data rate and
the reminder of the data (ND) will be transmitted via a not specifically secured interface (VB, WLAN, B) at a high data rate.

2. Method in accordance with claim 1, in which
basic data for restoring basic information is selected and/or transmitted as the part of the data to be transferred securely (CD) and
the data supplementing the basic information (ND) will be selected and/or transmitted as the remainder of the data (ND).

3. Method in accordance with claim 1 in which
a code to decrypt coded data (ND) will be transmitted as the part of the data to be securely transmitted (CD) and
at least a subset of the remaining part of the data (ND) will be transmitted as data (ND) encrypted with the code (CD).

4. Method in accordance with claim 3, in which
data arriving, or existing data (D) will be encrypted in a send-side division device (DIV) at least partly with a code (C), in which case
the code (C) is forwarded to the secure interface (VA, GSM, A) and
the encrypted data (ND) is forwarded to the not specifically secured interface (VB, WLAN, B), and
in a receive-side combining device (COMB) the data received via the receiving interface (VA, GSM, A, VB, BLAN, B) is again decrypted accordingly and output as constructed data (D).

5. Method in accordance with claim 4, in which billing-relevant data with reference to the remaining part of the data (ND) is transmitted as data to be transmitted securely (CD) in at least one direction via the secure interface (VA, GSM, A).

6. Method in accordance with claim 5, in which
a continuous connection will be established via a first of the interfaces and
temporary connections will be established where required via the other interface.

7. Method in accordance with claim 6, in which when it is possible to establish a temporary connection via the other interface (VB) at least a part of the data (ND) will be transmitted via this interface and otherwise via the interface with the continuous connection.

8. Data processing device (DIV) for a communications system device (GSM; WLAN) with
a data input for entry of data (D) to be transmitted via an interface (VA;VB),
a data processing device (DIV) for processing the data to be transmitted (D),
a first data output for outputting data (D) transmitted via the interface (VA) and
a further data output for outputting further data to be transmitted (D),
where the first data output for transmitting parts of the data to be transmitted securely (CD) with a secure interface (VA, GSM) with a low data rate and the further data output for transmitting further parts of the data (ND) is connected to a not specifically secured interface (VB, WLAN) with a high data rate.

9. Data processing device (COMB) for a communications system device (GSM, WLAN) with
a first data input for entry of data received (D) via the interface (VA),
a further data input for entering further data (D) received via an interface (VB),
a processing device (COMB) for processing the received data (D) and
a data output for outputting data (D) processed in the processing device (COMB),
where the processing device (COMB) is connected via the first data input for receiving a securely transmitted part of the data (CD) with a secure interface (VA, GSM) with a low data rate and connected via the further data input for receiving further parts of the data (ND) to a not specifically secured interface (VB, WLAN) with a high data rate.
